(19) United States
(12) Patent Application Publication
(10) Pub. No.: US 2007/0241837 A1
(43) Pub. Date: Oct. 18, 2007

(54) Matrix Switch

(76) Inventor: Hideki Kamitsuna, Kanagawa (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/587,287

(22) PCT Filed: Mar. 7, 2006
(86) PCT No.: PCT/JP06/04361

§ 371 Date: Oct. 18, 2006

(30) Foreign Application Priority Data
Mar. 9, 2005 (JP) 2005-065824

(51) Int. Cl. H01P 1/15

(52) U.S. Cl. 333/103; 333/105; 370/367

(57) ABSTRACT

Four SP4T switches (3₁-3₄) are grouped in twos to form two switch pairs. First conductive lines (4₁₁-4₁₄, 4₂₁-4₂₄) are arranged in fours between the SP4T switches (3₁, 3₄; 3₂, 3₃) constituting the switch pairs. Each of four second conductive lines (5₁-5₄) connects to a corresponding one of different conductive lines of the first conductive lines which connect to the respective switch pairs. The first and second conductive lines are arranged on a dielectric layer having a lower surface on which a ground conductor (6) is formed. The dielectric, layer has a two-layer structure. The first conductive lines are arranged on the first dielectric layer as a lower layer. The second conductive lines are arranged on the second dielectric layer as an upper layer. This arrangement makes it possible to attain a reduction in the size of a matrix switch and a reduction in loss and allow broadband operation.

### TECHNICAL FIELD

The present invention relates to a matrix switch which outputs a signal from an arbitrary input terminal to an arbitrary output terminal by switching signal paths between a plurality of input terminals and a plurality of output terminals and, more particularly, to a matrix switch including a plurality of 1×n switches (n is an even number equal to or more than 2).

### BACKGROUND ART

A multi-input/multi-output matrix switch is used to, for example, switch signal paths at nodes in a network. A conventional n-input/n-output switch comprises n 1-input/n-output switches, n n-input/1-output switches, and n² connection means for connecting the switches to each other. Reference 1 (Japanese Patent Laid-Open No. 9-9312) discloses an example of such an n-input/n-output switch. The n-input/n-output switch disclosed in reference 1 has an arrangement which can be applied as a cross-connect switch which can output input signals from n input terminals 101₁ to 101ₙ in all combinations to n output terminals 102₁ to 102ₙ, as shown in FIG. 19. This arrangement will be described in more detail below by exemplifying the case of n=4.

As shown in FIG. 20, a conventional 4-input/4-output switch (4×4 switch) includes eight Single-Pole 4-Throw (SP4T) switches 103₁ to 103₈ in correspondence with input terminals 101₁ to 101₄ and output terminals 102₁ to 102₄. The SP4T switches 103₁ to 103₈ are bidirectional switches, each functioning both as an 1-input/4-output switch and a 4-input/1-output switch.

Each of the SP4T switches 103₁ to 103₈ includes one common terminal and four individual terminals. Sixteen interconnection transmission lines 104₁₁ to 104₄₄ connect the individual terminals of the SP4T switches 103₁ to 103₄ on the input side to the individual terminals of the SP4T switches 103₅ to 103₈ on the output side. Each of the SP4T switches 103₁ to 103₈ is designed such that the common terminal connects to one of the four individual terminals (does not connect to the remaining three terminals). These switches are controlled as a whole such that the four input terminals 10₁₁ to 10₁₄ one-to-one connect to the four output terminals 102₁ to 102₄. Referring to FIG. 20, the symbol “◯” with a satin-like pattern indicates an interconnection intersection 116 where two transmission lines intersect each other but do not electrically connect to each other.

### DISCLOSURE OF INVENTION

### Problem to be Solved by the Invention

The following problems arise in the conventional matrix switch.

The first problem is that it is difficult to achieve low insertion loss and high isolation while reducing the circuit size. This problem originates from the necessity to make the interconnection transmission lines 104₁₁ to 104₄₄ have finite lengths and not a little increase in insertion loss caused by the finite lengths. When the transmission lines 104₁₁ to 104₄₄ comprise, for example, coplanar waveguides, in order to reduce insertion loss, it is necessary to increase the central conductor width and the gap between the central conductor and the ground conductor. This is because the characteristic impedance of a coplanar waveguide is almost uniquely determined by the central conductor width and the above gap.

On the other hand, a matrix switch is required to have a high isolation characteristic between the respective paths. In this case, the isolation between coplanar waveguides increases as the ground conductor width between the lines increases. In order to attain characteristics with a low insertion loss and high isolation, it is necessary to increase both the central conductor width and the ground conductor width. However, in a matrix switch in which transmission lines are arranged at a high density, each connection path inevitably becomes long. This greatly cancels out the above reducing effect of insertion loss.

An increase in the length of connection paths amounts to an increase in circuit size. When a matrix switch is to be integrated on a semiconductor substrate, in particular, this increase in circuit size causes an increase in cost. Letting n be the numbers of input terminals 101₁ to 101ₙ and output terminals 102₁ to 102ₙ, the required number of connection paths is the square of n. Therefore, the larger the switch size, the more conspicuous these problems become. This poses a serious problem in the matrix switch with a size of 4×4 or more shown in FIG. 20.

The second problem is that as the numbers of input terminals 101₁ to 101ₙ and output terminals 102₁ to 102ₙ increase, the number of connection path intersections increases, and the isolation characteristic deteriorates. In the 4×4 switch shown in FIG. 20, there are as many as 36 interconnection intersections. The number of interconnection intersections in an 8×8 switch reaches as many as 784. As described above, the larger the size of a matrix switch, the larger the number of interconnection intersections becomes, resulting in a deterioration in isolation characteristic.

The third problem is that an increase in the number of switch control lines will cause a deterioration in isolation characteristic. This problem originates from the necessity to provide switches on both the input and output sides. If SPnT switches each functioning both as a 1-input/n-output switch and an n-input/1-output switch require n control lines each, a 4×4 switch requires 32 control lines, and an 8×8 switch requires as many as 128 control lines. These control lines inevitably intersect the interconnection transmission lines 104₁₁ to 104₄₄. This leads to a deterioration in isolation characteristic.

The fundamental cause of the above problems in the prior art is that n 1-input/n-output switches and n n-input/1-output switches are respectively arranged on both the input and output sides. That is, the problems originate from the necessity of n² interconnection transmission lines for connecting these switches.

This conventional matrix switch operates even if the switches on either the input side or the output side are removed. For example, even if the SP4T switches 103₅ to 103₈ on the output side in FIG. 20 are removed, the resultant structure operates as a 4×4 switch. In this case, however, transmission lines coupled to the OFF terminals of the SP4T switches 103₁ to 103₄ on the input side become open stubs when viewed from the output terminals 102₁ to 102₄. An OFF terminal is an individual terminal which does not connect to a common terminal. An open stub is a portion which branches off from a main transmission line and has an open end. A 4×4 switch has three open stubs for each output terminal, and an 8×8 switch has seven open stubs for each output terminal. Open stubs increase capacitance. As a result, return loss increases with an increase in frequency. This makes it difficult to perform broadband operation at several GHz or more.

Decreasing the length of an open stub makes it possible to reduce the capacitance caused by the open stub. The length of an open stub almost corresponds to the interval between an input-side switch and an output-side switch. As the interval between two switches, a 4×4 switch requires a length corresponding a space where at least 16 interconnection transmission lines are arranged, and an 8×8 switch requires a space where 64 interconnection transmission lines are arranged. The length of an open stub can therefore decrease as the width of a transmission line and a transmission line interval decrease. However, consideration must be given to the tradeoff with insertion loss and isolation characteristic.

The capacitance caused by an open stub can also be reduced by increasing the characteristic impedance of an interconnection transmission line. For example, however, in order to increase the characteristic impedance of a coplanar waveguide, the interval between the central conductor and the ground conductor must be increased. This leads to an increase in the length of an interconnection transmission line which becomes an open stub, and greatly cancels out the characteristic impedance increasing effect.

It is, therefore, an object of the present invention to downsize a matrix switch.

It is another object of the present invention to reduce the insertion loss of a matrix switch.

It is still another object of the present invention to improve the isolation characteristic of a matrix switch.

It is still another object of the present invention to enable a matrix switch to perform broadband operation.

### MEANS OF SOLUTION TO THE PROBLEM

In order to achieve the above objects, a matrix switch according to the present invention is characterized by comprising n (n is an even umber not less than 2) 1×n switches which are grouped in twos to form switch pairs, first conductive lines arranged in ns for each switch pair, n second conductive lines which respectively connect to different lines of the first conductive lines which are respectively arranged on the switch pairs, a dielectric layer on which the first conductive lines and the second conductive lines are separately arranged on not less than two layers, and a ground conductor which forms a transmission line together with at least one of the first conductive line and the second conductive line and the dielectric layer, wherein the 1×n switch comprises one common terminal and n individual terminals arranged on a side different from that of the common terminal, two 1×n switches forming the switch pair are arranged such that individual terminals of the 1×n switches are spaced apart from each other to face each other, and the first conductive lines connect the respective individual terminals of the two 1×n switches to each other.

### EFFECTS OF THE INVENTION

According to the present invention, the number of conductive lines existing between two 1×n switches forming a switch pair can decrease from n² in the prior art to n. When conductive lines with the same line width and the same line interval as those in the prior art are used, the space where the conductive lines are arranged decreases. Since a required 1×n switch reduces to ½ that in the prior art, the matrix switch can be reduced in size. A reduction in size can achieve a reduction in cost.

In addition, decreasing the interval between the two 1×n switches to 1/n that in the prior art makes it possible to decrease the length of open stubs. This reduces the capacitance caused by the open stubs and hence allows operation in a broad bandwidth of several GHz or more.

Furthermore, since the transmission line length between an input terminal and an output terminal in the ON state decreases, insertion loss decreases, and the path dependency of insertion loss decreases.

Moreover, since the number of interconnection intersections decreases, the isolation characteristic improves.

### BRIEF DESCRIPTION OF DRAWINGS

FIG. 1 is a block diagram showing the arrangement of a matrix switch according to the first embodiment of the present invention;

FIG. 2 is a view showing the arrangement of an SP4T switch;

FIG. 3 is a cross-sectional view taken along a line A-A in FIG. 1;

FIG. 4 is a block diagram showing a modification of the matrix switch shown in FIG. 1;

FIG. 5 is a cross-sectional view taken along a line B-B in FIG. 4;

FIG. 6 is a graph showing simulation results on a 4×4 switch according to the first embodiment;

FIG. 7 is a graph showing simulation results on a 4×4 switch with a conventional arrangement;

FIG. 8A is a plan view showing an outline of an example of the interconnection structure of a matrix switch according to the second embodiment of the present invention;

FIG. 8B is a cross-sectional view taken along a line C-C′ in FIG. 8A;

FIG. 9A is a plan view showing an outline of another example of the interconnection structure of the matrix switch according to the second embodiment of the present invention;

FIG. 9B is a cross-sectional view taken along a line D-D′ in FIG. 9A;

FIG. 10A is a block diagram showing an example of the arrangement of a matrix switch according to the third embodiment of the present invention;

FIG. 10B is a plan view showing an outline of the interconnection structure of the matrix switch shown in FIG. 10A;

FIG. 10C is a cross-sectional view taken along a line E-E′ in FIG. 10B;

FIG. 11A is a plan view showing an outline of another example of the interconnection structure of the matrix switch according to the third embodiment of the present invention;

FIG. 11B is a cross-sectional view taken along a line F-F′ in FIG. 11A;

FIG. 11C is a cross-sectional view taken along a line H-H′ in FIG. 11A;

FIG. 12A is a plan view showing an outline of another example of the interconnection structure of the matrix switch according to the third embodiment of the present invention;

FIG. 12B is a cross-sectional view taken along a line I-I′ in FIG. 12A;

FIG. 12C is a cross-sectional view taken along a line J-J′ in FIG. 12A;

FIG. 13A is a circuit diagram showing a matrix switch according to the fourth embodiment of the present invention;

FIG. 13B is a block diagram showing the connection relationship between an SP4T switch and a controller;

FIG. 14 is a block diagram showing the arrangement of a matrix switch according to the fifth embodiment of the present invention;

FIG. 15 is a block diagram showing the arrangement of a matrix switch according to the sixth embodiment of the present invention;

FIG. 16 is a block diagram showing a modification of the matrix switch shown in FIG. 1;

FIG. 17A is a block diagram showing an example of the arrangement of a 2×2 switch to which the present invention is applied;

FIG. 17B is a block diagram showing another example of the arrangement of the 2×2 switch to which the present invention is applied;

FIG. 18 is a block diagram showing an example of the arrangement of a 16×16 switch to which the present invention is applied;

FIG. 19 is a block diagram showing the arrangement of a conventional n-input/n-output switch; and

FIG. 20 is a block diagram showing the arrangement of a conventional 4×4 switch.

### BEST MODE FOR CARRYING OUT THE INVENTION

The embodiments of the present invention will be described in detail below with reference to the accompanying drawings.

### First Embodiment

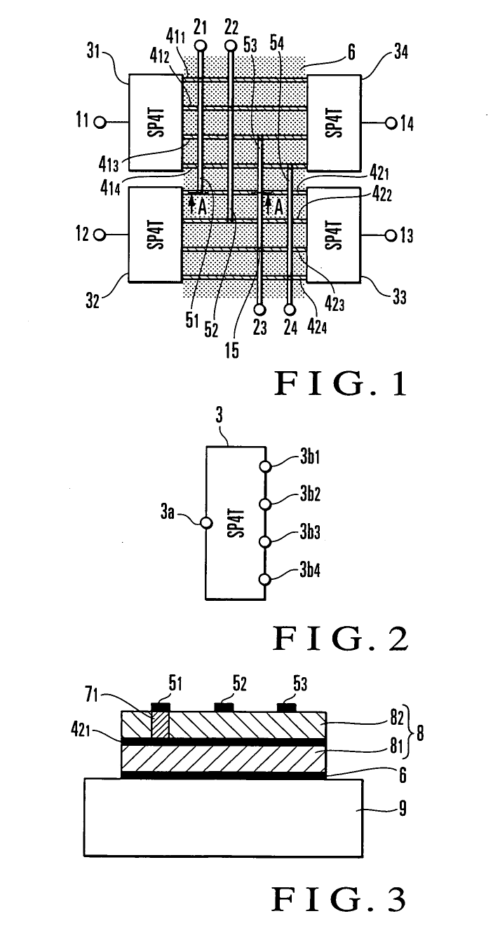

As shown in FIG. 1, a matrix switch according to the first embodiment of the present invention is a 4×4 switch including four input terminals (first terminals) 1₁ to 1₄, four output terminals (second terminals) 2₁ to 2₄, and four SP4T switches 3₁ to 3₄.

Each of the SP4T switches 3₁ to 3₄ is a 1×4 switch including one common terminal 3a and four individual terminals 3b₁ to 3b₄ like a SP4T switch 3 shown in FIG. 2. The common terminal 3a and the individual terminals 3b₁ to 3b₄ are arranged on opposite sides of the switch. Each of the SP4T switches 3₁ to 3₄ is controlled such that the common terminal 3a of the self-switch selectively connects to one of the individual terminals 3b₁ to 3b₄ while not connecting to the remaining three terminals. Therefore, each of the SP4T switches 3₁ to 3₄ outputs a signal input from the common terminal 3a to one of the individual terminals 3b₁ to 3b₄, and outputs a signal input from one of the individual terminals 3b₁ to 3b₄ to the common terminal 3a. Each of the SP4T switches 3₁ to 3₄ is a bidirectional switch functioning both as a 1-input/4-output switch and a 4-input/1-output switch. Note that it suffices if the common terminal 3a and the individual terminals 3b₁ to 3b₄ are arranged on different sides of the switch. That is, the terminals 3a and 3b₁ to 3b₄ may be arranged on adjacent sides of the switch.

The four SP4T switches 3₁ to 3₄ are grouped in twos to form two switch pairs. More specifically, the SP4T switches 3₁ and 3₄ constitute the first switch pair, and the SP4T switches 3₂ and 3₃ constitute the second switch pair. The SP4T switches 3₁ and 3₄ constituting the first switch pair are arranged such that the individual terminals 3b₁ to 3b₄ of one switch face those of the other switch. The SP4T switches 3₂ and 3₃ constituting the second switch pair are arranged in the same manner.

In the first switch pair, the four individual terminals 3b₁ to 3b₄ of the SP4T switch 3₁ connect to the four individual terminals 3b₁ to 3b₄ of the SP4T switch 3₄ via four first conductive lines 4₁₁ to 4₁₄. Likewise, in the second switch pair, the four individual terminals 3b₁ to 3b₄ of the SP4T switch 3₂ connect to the four individual terminals 3b₁ to 3b₄ of the SP4T switch 3₃ via four first conductive lines 4₂₁ to 4₂₄. The first conductive lines 4₁₁ to 4₁₄ and 4₂₁ to 4₂₄ are arranged parallel to each other.

The first conductive lines 4₁₁ to 4₁₄ respectively connect to the first conductive lines 4₂₁ to 4₂₄ via second conductive lines 5₁ to 5₄. More specifically, the first conductive lines 4₁₁ and 4₂₁ connect to each other via the second conductive line 5₁; the first conductive lines 4₁₂ and 4₂₂, via the second conductive line 5₂; the first conductive lines 4₁₃ and 4₂₃, via the second conductive line 5₃; and the first conductive lines 4₁₄ and 4₂₄, via the second conductive line 5₄. The second conductive lines 5₁ to 5₄ are arranged parallel to each other in a direction to intersect the first conductive lines 4₁₁ to 4₁₄ and 4₂₁ to 4₂₄ (a direction to perpendicular to them in FIG. 1).

The input terminals 1₁ to 1₄ to which signals are input connect to the common terminals 3a of the SP4T switches 3₁ to 3₄. End portions of the second conductive lines 5₁ to 5₄ are extracted outside the area where the conductive lines 4₁₁ to 4₁₄ and 4₂₁ to 4₂₄ are arranged and connect to the output terminals 2₁ to 2₄ from which signals are output. The SP4T switches 3₁ to 3₄ are controlled as a whole such that the four input terminals 1₁ to 1₄ one-to-one connect to the four output terminals 2₁ to 2₄.

A cross-sectional arrangement of the matrix switch shown in FIG. 1 will be described next with reference to FIG. 3. The first conductive lines 4₁₁ to 4₁₄ and 4₂₁ to 4₂₄ and the second conductive lines 5₁ to 5₄ constitute microstrip lines (transmission lines) together with a ground conductor 6 formed on a substrate 9 and a dielectric layer 8 formed on the ground conductor 6.

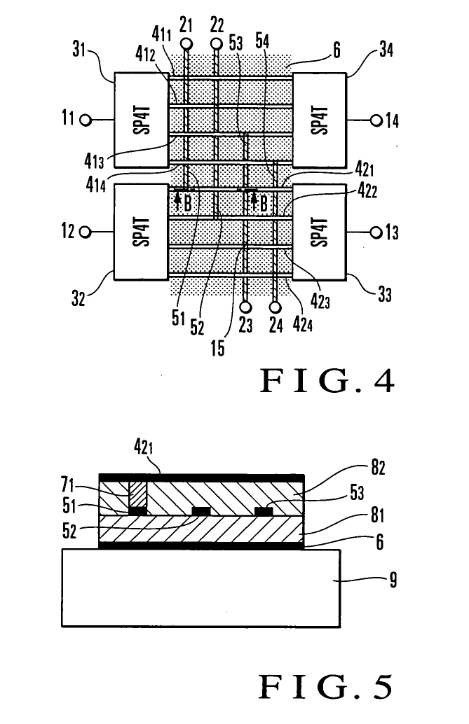

The dielectric layer 8 has a two-layer structure comprising a first dielectric layer 8₁ and a second dielectric layer 8₂. The first dielectric layer 8₁ is stacked on the ground conductor 6, and the second dielectric layer 8₂ is stacked on the first dielectric layer 8₁. The first conductive lines 4₁₁ to 4₁₄ and 4₂₁ to 4₂₄ are arranged on the first dielectric layer 8₁, and the second conductive lines 5₁ to 5₄ are arranged on the second dielectric layer 8₂. The first conductive lines 4₁₃ to 4₁₄ and 4₂₁ to 4₂₄ connect to the second conductive lines 5₁ to 5₄ at connecting portions 15 indicated by “▪” in FIG. 1 via through holes 7₁ formed in the second dielectric layer 8₂. Although reference numeral “15” denoting a connecting portion is attached to only one symbol “▪” in FIG. 1, the remaining symbols “▪” indicate the connecting portions 15. This applies to FIGS. 4, 14, 16, and 18 to be described later. FIG. 3 is a view for explaining a state wherein two conductive lines connect to each other via a dielectric layer, with an illustration of the second conductive line 5₄ being omitted.

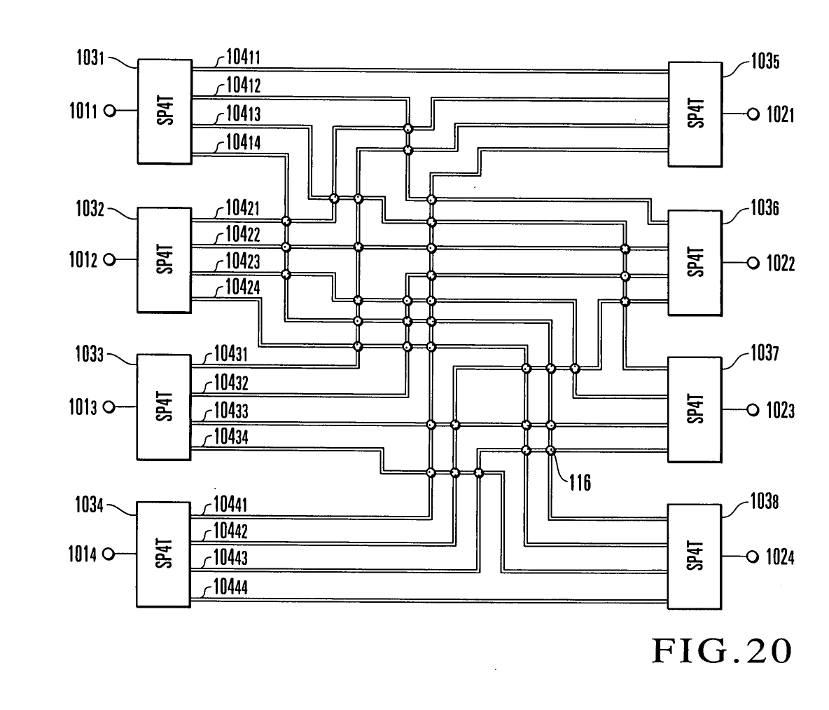

The above arrangement makes it possible to decrease the number of conductive lines existing between the opposite switches of the respective switch pairs from 16 in the prior art shown in FIGS. 20 to 4 (the second conductive lines 5₁ to 5₄). If, therefore, conductive lines with the same line width and the same line interval are used, the interval between the SP4T switches 3₁ and 3₄ and between the SP4T switches 3₂ and 3₃ of the first and second switch pairs can decrease to about ¼ that in the prior art.

At switching operation, in each of the SP4T switches 3₁ to 3₄, the first conductive lines coupled to the OFF terminals become open stubs, together with some of the second conductive lines in some case. Therefore, at switching operation, three open stubs exist for each of the output terminals 2₁ to 2₄. As described above, decreasing the interval between the SP4T switches 3₁ and 3₄ and between the SP4T switches 3₂ and 3₃ makes it possible to decrease the length of each open stub to about 1/12 that in the prior art. This allows broadband operation in a bandwidth 10 times or more as wide as that in the arrangement of the prior art in which the SP4T switches 103₅ to 103₈ on the output side are removed. Furthermore, since the length of the transmission lines between input terminals and output terminals in the ON state decreases, insertion loss can be reduced while the path dependency of insertion loss can be reduced.

In addition, the number of interconnection intersections can decrease from 36 in the prior art shown in FIGS. 20 to 14, and an improvement in isolation characteristic can be attained. Furthermore, for example, as shown in FIG. 3, the ground conductor 6 and the dielectric layers 8₁ and 8₂ are sequentially formed on the substrate 9, with the dielectric layers 8₁ and 8₂ having a thickness of several μm to several ten μm. This structure makes it possible to maintain high inter-line isolation even if the line interval is decreased as compared with microstrip lines using a substrate lower surface ground and coplanar waveguides formed on a substrate upper surface. Therefore, a switch with a broader bandwidth can be implemented. Moreover, the above structure can increase a characteristic impedance with a narrow line interval as compared with coplanar waveguides, and hence makes it easy to reduce the capacitance caused by an open stub, thereby improving return loss.

The matrix switch shown in FIGS. 4 and 5 is a modification of the matrix switch shown in FIGS. 1 and 3. The second conductive lines 5₁ to 5₄ are arranged on the first dielectric layer 8₁, and the first conductive lines 4₁₁ to 4₁₄ and 4₂₁ to 4₂₄ are arranged on the second dielectric layer 8₂. This arrangement can obtain the same effects as those of the matrix switch shown in FIGS. 1 and 3. Note that an illustration of the second conductive line 5₄ is omitted in FIG. 5 as well for the same reason as that for FIG. 3.

In the matrix switch shown in FIGS. 3 and 5, the conductive line width on the first dielectric layer 8₁ is preferably smaller than that on the second dielectric layer 8₂. This makes it possible to reduce the characteristic impedance difference between the conductive lines on the first dielectric layer 8₁ and the conductive lines on the second dielectric layer 8₂. Both the characteristic impedances can be equalized. This makes it possible to improve the characteristics of the switch.

According to the matrix switch shown in FIGS. 1 and 4, it was confirmed that a 4×4 switch with a bandwidth of about 20 GHz could be implemented by setting the line widths of the first conductive lines 4₁₁ to 4₁₄ and 4₂₁ to 4₂₄ and the second conductive lines 5₁ to 5₄ to about 5 to 10 μm, the thicknesses of the lines to about 1 to 5 μm, and the thicknesses of the first and second dielectric layers 8₁ and 8₂ to about 2 to 5 μm (dielectric constant: about 3).

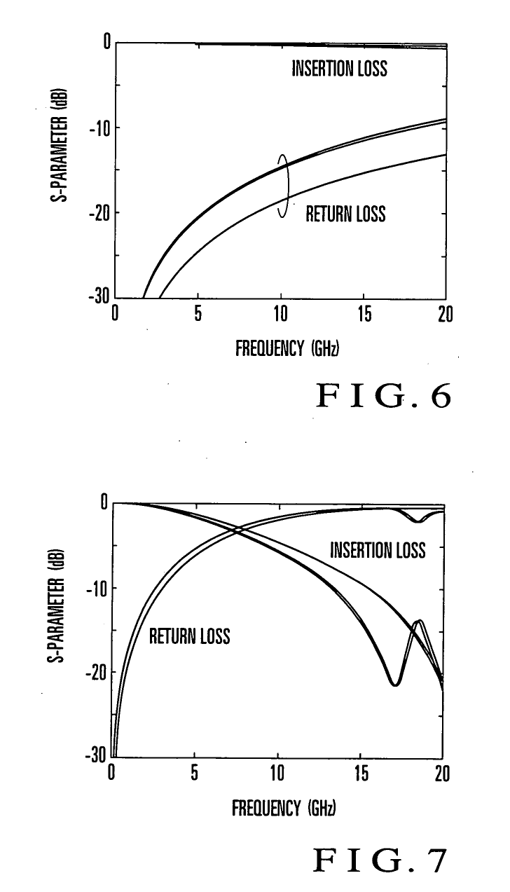

FIG. 6 shows the simulation result obtained from a 4×4 switch designed with the above dimensions. For comparison, FIG. 7 shows the simulation result obtained from a 4×4 switch with a conventional arrangement. In this case, a 4×4 switch with a conventional arrangement is assumed to be the switch obtained by removing the output-side SP4T switches 103₅ to 103₈ of the matrix switch shown in FIG. 20, and connecting end portions of the interconnection transmission lines 104₁₁ to 104₁₄, 104₂₁ to 104₂₄, 104₃₁ to 104₃₄, and 104₄₁ to 104₄₄ to which the individual terminals of the SP4T switches 103₅ to 103₈ have connected.

Bandwidths are compared in which return losses become −10 dB or less. In the conventional arrangement shown in FIG. 7, such a loss appears at 2.7 GHz. In this embodiment, as shown in FIG. 6, such a loss appears at 17 GHz. Obviously, this embodiment greatly broadens the bandwidth in which the return loss becomes −10 dB or less. It was also confirmed that the insertion loss could be greatly improved.

### Second Embodiment

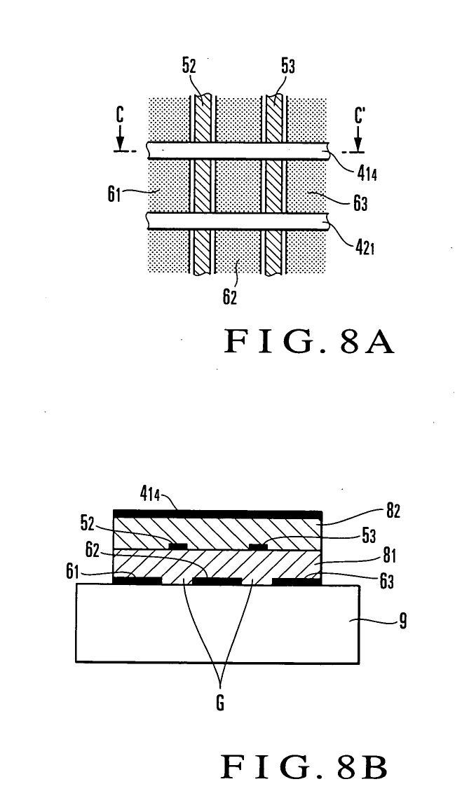

The matrix switch shown in FIGS. 8A and 8B is a modification of the matrix switch shown in FIGS. 4 and 5. In this matrix switch, gaps G are formed in a ground conductor 6 immediately below second conductive lines 5₁ to 5₄ arranged on a first dielectric layer 8₁. This reduces the capacitances of the second conductive lines 5₁ to 5₄, and hence can increase the characteristic impedance without decreasing the line width of the second conductive lines 5₁ to 5₄.

Preferably, the line width of the second conductive lines 5₁ to 5₄ on the first dielectric layer 8₁ is set to be almost equal to that of first conductive lines 4₁₁ to 4₁₄ and 4₂₁ to 4₂₄ on a second dielectric layer 8₂, and the widths of the gaps G in the ground conductor 6 are set such that the characteristic impedance of the second conductive lines 5₁ to 5₄ becomes equal to that of the first conductive lines 4₁₁ to 4₁₄ and 4₂₁ to 4₂₄. Referring to FIG. 8, ground conductors 6₁, 6₂, and 6₃ are ground conductors which connect to the same potential.

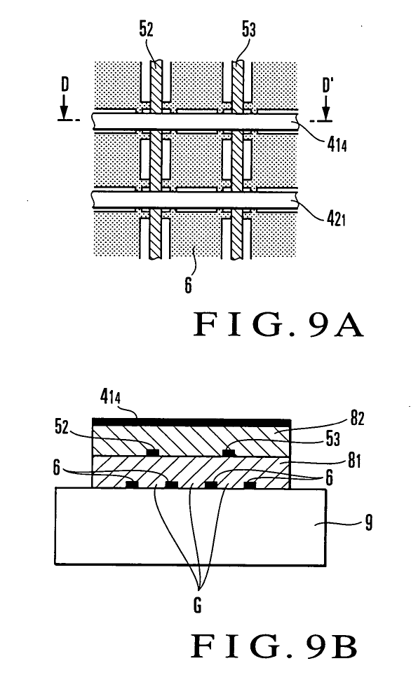

The matrix switch shown in FIGS. 9A and 9B is another modification of the matrix switch shown in FIGS. 4 and 5. In this matrix switch, the gaps G are formed in the ground conductor 6 immediately below the first and second conductive lines 4₁₁ to 4₁₄, 4₂₁ to 4₂₄, and 5₁ to 5₄ except for intersection areas between the second conductive lines 5₁ to 5₄ arranged on the first dielectric layer 8₁ and the first conductive lines 4₁₁ to 4₁₄ and 4₂₁ to 4₂₄ arranged on the second dielectric layer 8₂. This arrangement can further increase the characteristic impedances.

Preferably, the line width of the second conductive lines 5₁ to 5₄ on the first dielectric layer 8₁ is smaller than that of the first conductive lines 4₁₁ to 4₁₄ and 4₂₁ to 4₂₄ on the second dielectric layer 8₂, and the widths of the gaps G in the ground conductor 6 are set such that the characteristic impedance of the second conductive lines 5₁ to 5₄ becomes equal to that of the first conductive lines 4₁₁ to 4₁₄ and 4₂₁ to 4₂₄. This arrangement can greatly reduce the capacitance caused by open stubs by increasing the characteristic impedances. As a consequence, the return loss can be improved, and hence a matrix switch with a broader bandwidth can be implemented.

Note that this embodiment can also be applied to a case wherein the first conductive lines 4₁₁ to 4₁₄ and 4₂₁ to 4₂₄ are arranged on the first dielectric layer 8₁, and the second conductive lines 5₁ to 5₄ are arranged on the second dielectric layer 8₂.

### Third Embodiment

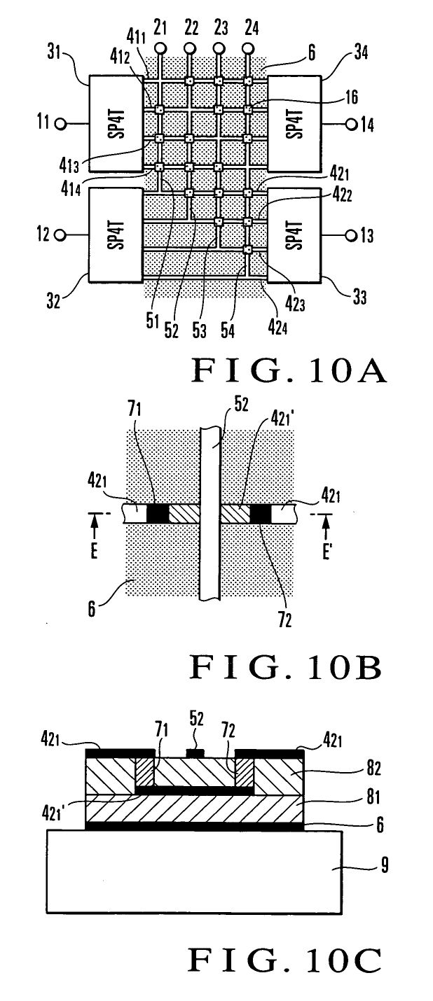

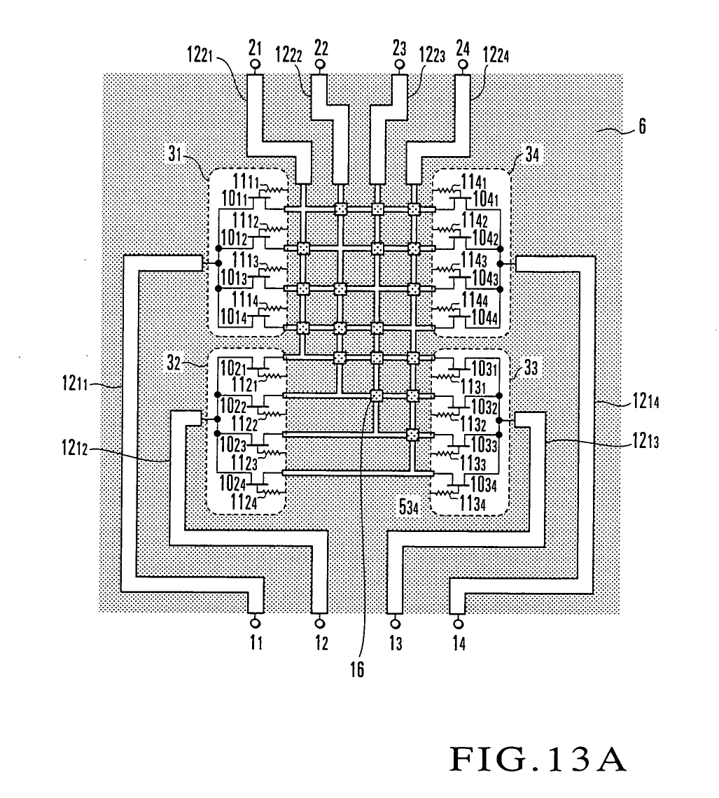

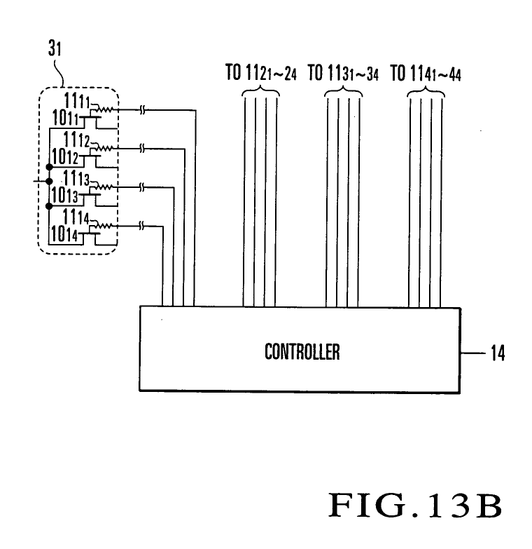

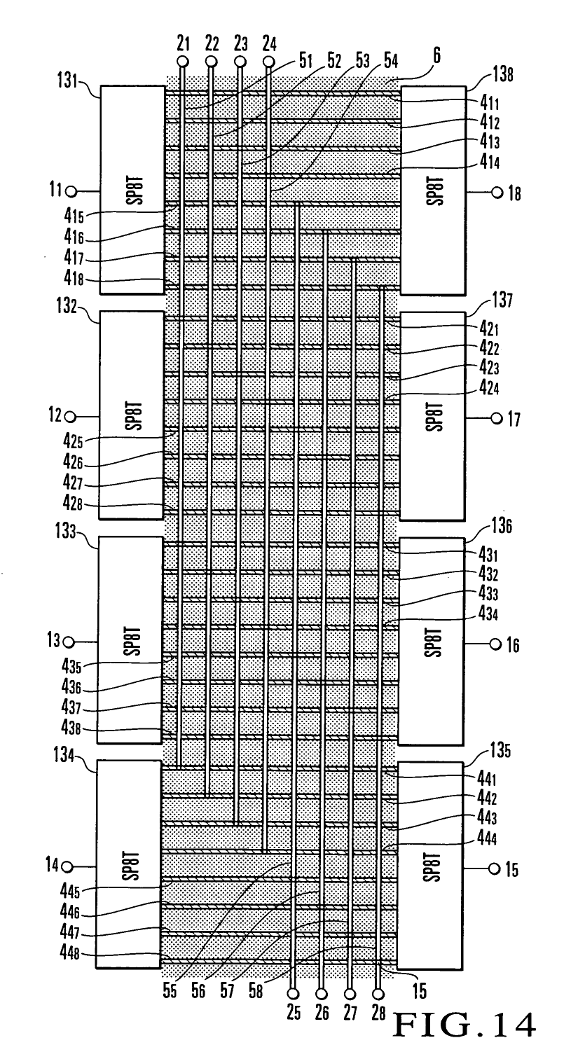

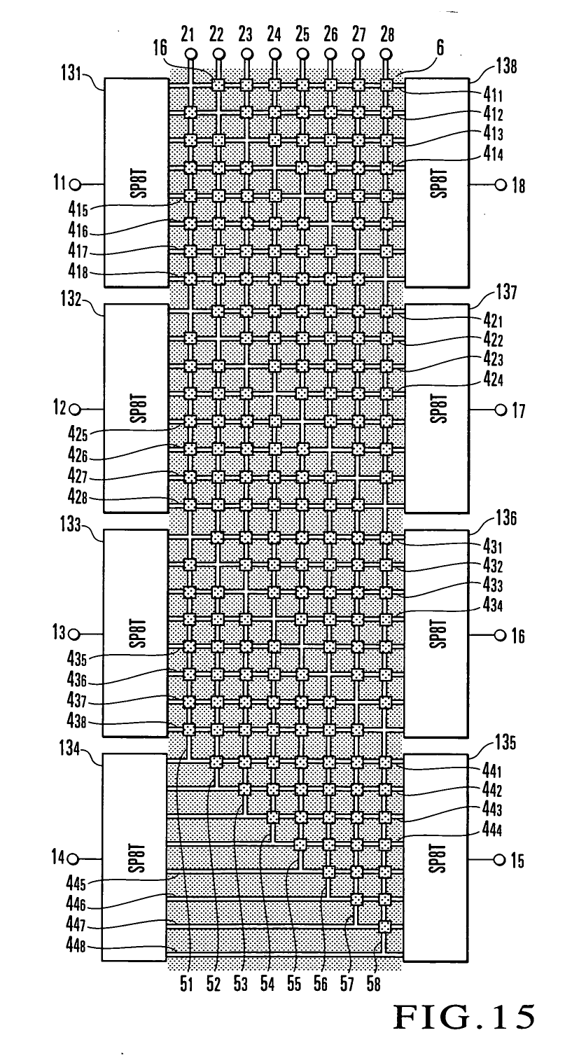

The matrix switch shown in FIGS. 10A to 10C is a modification of the matrix switch shown in FIGS. 1 and 3. In this matrix switch, output terminals 2₁ to 2₄ are gathered on one side of the matrix switch. In addition, first and second conductive lines 4₁₁ to 4₁₄, 4₂₁ to 4₂₄, and 5₁ to 5₄ are formed on a second dielectric layer 8₂ in orthogonal directions. Note that portions of the first conductive lines 4₁₁ to 4₁₄ and 4₂₁ to 4₂₄ (only a conductive line 4₂₁ is shown FIGS. 10B and 10C) are formed on a first dielectric layer 8₁ at intersects 16 between the first conductive lines 4₁₁ to 4₁₄ and 4₂₁ to 4₂₄ and the second conductive lines 5₁ to 5₄ except for the connecting portions. These portions of the first conductive lines 4₁₁ to 4₁₄ and 4₂₁ to 4₂₄ connect to the remaining portions of the first conductive lines 4₁₁ to 4₁₄ and 4₂₁ to 4₂₄ on the second dielectric layer 8₂ via through holes 7₁ and 7₂ and the like formed in the second dielectric layer 8₂. Although reference numeral “16” denoting an intersection is attached to only one portion in FIG. 10A, all the symbols “□” with satin-like patterns indicate intersections 16. This applies to FIGS. 13A and 15 to be described later.

This arrangement allows all the transmission lines to have the same arrangement except for the intersections 16. In addition, since the conductor thickness of the uppermost layer can be made larger than that of the remaining layers, the insertion loss can be easily reduced. Note that portions of the second conductive lines 5₁ to 5₄ may be formed on the first dielectric layer 8₁ at the intersections 16 and connect to the remaining portions on the second dielectric layer 8₂ via through holes.

The conductive line width on the first dielectric layer 8₁ is preferably smaller than that on the second dielectric layer 8₂. This can decrease the characteristic impedance difference between the conductive lines on the first dielectric layer 8₁ and the conductive lines on the second dielectric layer 8₂, and hence can improve the characteristics of the matrix switch. In addition, gathering the output terminals 2₁ to 2₄ on one side of the matrix switch makes it easy to extract input and output terminals in opposite directions, as shown in FIG. 13.

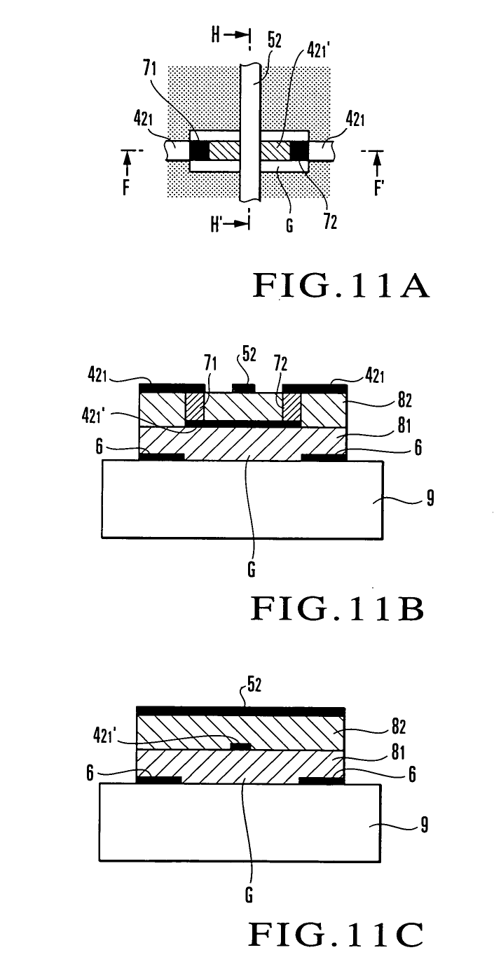

The matrix switch shown in FIGS. 11A to 11C is a modification of the matrix switch shown in FIGS. 10A to 10C. In this matrix switch, gaps G are formed in a ground conductor 6 immediately below a conductive line 4₂₁ and the like on the first dielectric layer 8₁. This reduces the capacitances of the transmission lines, and hence can increase characteristic impedances without decreasing the line widths of a conductive line 42₁₁′ and the like. Preferably, the conductive line width on the first dielectric layer 8₁ is set to be almost equal to that on the second dielectric layer 8₂, and the widths of the gaps G are set such that the characteristic impedance of the conductive lines on the first dielectric layer 8₁ becomes equal to that of the conductive lines on the second dielectric layer 8₂. This makes it possible to further reduce the insertion loss of the matrix switch.

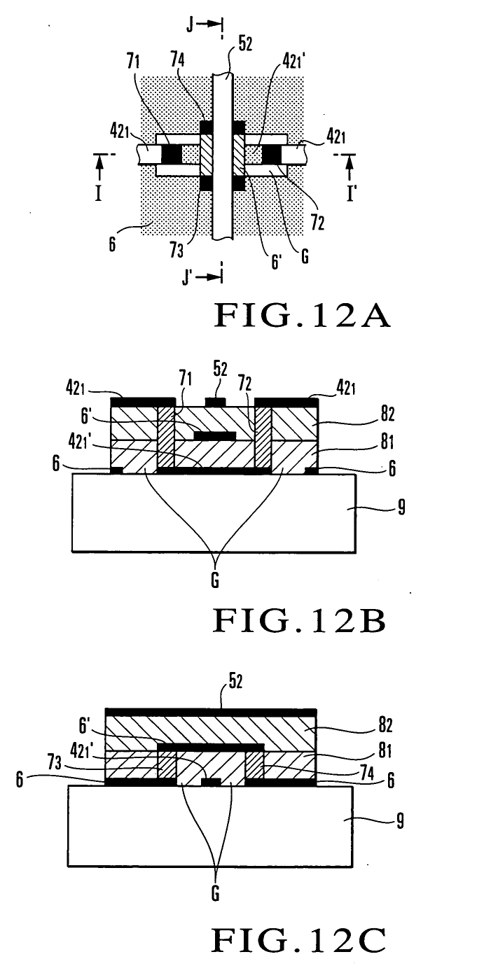

The matrix switch shown in FIGS. 12A to 12C is a modification of the matrix switch shown in FIGS. 10A to 10C. In this matrix switch, the gaps G are formed in the ground conductor 6 on a substrate 9 at the intersections between the first conductive lines 4₁₁ to 4₁₄ and 4₂₁ to 4₂₄ and the second conductive lines 5₁ to 5₄ except for the connecting portions. Portions of the first conductive lines 4₁₁ to 4₁₄ and 4₂₁ to 4₂₄ (only the conductive line 4₂₁ shown in FIGS. 12A to 12C) are formed in the areas on the substrate 9 in which the gaps G are formed (below the first dielectric layer 8₁). These portions of the first conductive lines 4₁₁ to 4₁₄ and 4₂₁ to 4₂₄ connect to the remaining portions of the first conductive lines 4₁₁ to 4₁₄ and 4₂₁ to 4₂₄ on the second dielectric layer 8₂ via the through holes 7₁ and 7₂ formed in the first and second dielectric layers 8₁ and 8₂. Conductors 6′ are formed on the first dielectric layer 8₁ immediately below the above intersections. The conductors 6′ connect to the ground conductor 6 on the substrate 9 via through holes 7₃ and 7₄ and the like formed in the first dielectric layer 8₁.

This can reduce the intersection capacitance of the conductive lines 4₂₁′ and 5₂, and hence can improve the isolation characteristic of the matrix switch. Note that portions of the second conductive lines 5₁ to 5₄ may be formed in the areas where the gaps G are formed, and connect to the remaining portions on the second dielectric layer 8₂ via through holes.

This embodiment is not limited to the above arrangement, and may be configured to extract the output terminals 2₁, 2₂, 2₃, and 2₄ from different sides as in the embodiment shown in FIG. 1. In addition, as in the embodiments shown in FIGS. 8A and 8B and FIGS. 9A and 9B, the gaps G may be formed in the ground conductor 6 immediately below the conductive lines on the second dielectric layer 8₂.

### Fourth Embodiment

As shown in FIG. 13A, a matrix switch according to the fourth embodiment of the present invention is equivalent to the matrix switch shown in FIG. 10 except that SP4T switches 3₁ to 3₄ comprise field-effect transistors (FETs) 10₁₁ to 10₁₄, 10₂₁ to 10₂₄, 10₃₁ to 10₃₄, and 10₄₁ to 10₄₄, and resistors 11₁₁ to 11₁₄, 11₂₁ to 11₂₄, 11₃₁ to 11₃₄, and 11₄₁ to 11₄₄. This arrangement will be described in more detail by taking the SP4T switch 3₁ as an example. One of the drain and source electrodes of each of the FETs 10₁₁ to 10₁₄ connects to the common terminal of the SP4T switch, and the other of the drain and source electrodes of each FET connects to an individual terminal of the SP4T switch. The gate electrodes of the EFTs 10₁₁ to 10₁₄ connect to a controller 14 via the resistors 11₁₁ to 11₁₄, as shown in FIG. 13B. Such an FET switch arrangement makes it possible to implement high-speed switching with zero power consumption, and to use a matrix switch by exchanging input and output terminals.

The controller 14 controls the SP4T switches 3₁ to 3₄ in the above manner. That is, the controller 14 controls each of the SP4T switches 3₁ to 3₄ such that the common terminal connects to only one of the four individual terminals. In the case of the SP4T switch 3₁, for example, V_{H} is applied to one of the resistors 11₁₁ to 11₁₄, and V_{L} is applied to the remaining three resistors. In addition, the matrix switch is controlled as a whole such that four input terminals 1₁ to 1₄ one-to-one connect to four output terminals 2₁ to 2₄.

In the matrix switch shown in FIG. 13A, the input terminals 1₁ to 1₄ and the output terminals 2₁ to 2₄ are arranged on different sides through the area where first conductive lines 4₁₁ to 4₁₄ and 4₂₁ to 4₂₄ and second conductive lines 5₁ to 5₄ are arranged. Conductive lines (third conductive lines) 12₁₁ to 12₁₄ of input transmission lines are interposed between the common terminals and the input terminals 1₁ to 1₄ of the SP4T switches 3₁ to 3₄. Conductive lines (fourth conductive lines) 12₂₁ to 12₂₄ of output transmission lines are interposed between end portions and the output terminals 2₁ to 2₄ of the second conductive lines 5₁ to 5₄. In this case, bending the third conductive lines 12₁₁ to 12₁₄ from the common terminals to the opposite side to the output terminals 2₁ to 2₄ makes it possible to gather the input terminals 1₁ to 1₄ on the opposite side to the output terminals 2₁ to 2₄.

The third and fourth conductive lines 12₁₁ to 12₁₄ and 12₂₁ to 12₂₄ are arranged on the second dielectric layer 8₂ in FIGS. 11B and 11C to form microstrip lines by using the ground conductor 6 and a common ground conductor inside the matrix switch. The third and fourth conductive lines 12₁₁ to 12₁₄ and 12₂₁ to 12₂₄ are not required to increase characteristic impedances unlike the first and second conductive lines 4₁₁ to 4₁₄ and 4₂₁ to 4₂₄ and 5₁ to 5₄ for interconnections. This makes it possible to increase the line widths as compared with the first and second conductive lines 4₁₁ to 4₁₄ and 4₂₁ to 4₂₄ and 5₁ to 5₄ so as to match an input/output of 50 O. In this embodiment as well, the first and second conductive lines 4₁₁ to 4₁₄, 4₂₁ to 4₂₄, and 5₁ to 5₄ may have the cross-sectional structures shown in FIGS. 3, 5, 8B, 9B, 11B, 11C, 12B, and 12C.

### Fifth Embodiment

A matrix switch according to the fifth embodiment of the present invention is an application of the 4×4 switch shown in FIGS. 1 and 3 to an 8×8 switch. As shown in FIG. 14, this matrix switch includes eight input terminals (first terminals) 1₁ to 1₈, eight output terminals (second terminals) 2₁ to 2₈, and eight SP8T switches 13₁ to 13₈.

The SP8T switches 13₁ to 13₈ each are a 1×8 switch including one common terminal and eight individual terminals. The eight SP8T switches 13₁ to 13₈ are grouped in twos to form four switch pairs. More specifically, the SP8T switches 13₁ and 13₈ constitute the first switch pair; the SP8T switches 13₂ and 13₇, the second switch pair; the SP8T switches 13₃ and 13₆, the third switch pair; and the SP8T switches 13₄ and 13₅, the fourth switch pair. The SP8T switches 13₁ and 13₈ constitute the first switch pair are spaced apart from each other such that their individual terminals face each other. The SP8T switches 13₂ and 13₇, 13₃ and 13₆, and 13₄ and 13₅ constituting the remaining switch pairs are arranged in the same manner.

In the first switch pair, the eight individual terminals of the SP8T switch 13₁ connect to the eight individual terminals of the SP8T switch 13₈ via eight first conductive lines 4₁₁ to 4₁₈. In the second switch pair, the eight individual terminals of the SP8T switch 13₂ connect to the eight individual terminals of the SP8T switch 13₇ via eight first conductive lines 4₂₁ to 4₂₈. In the third switch pair, the eight individual terminals of the SP8T switch 13₃ connect to the eight individual terminals of the SP8T switch 13₆ via eight first conductive lines 4₃₁ to 4₃₈. In the fourth switch pair, the eight individual terminals of the SP8T switch 13₄ connect to the eight individual terminals of the SP8T switch 13₅ via eight first conductive lines 4₄₁ to 4₄₈. The first conductive lines 4₁₁ to 4₁₈, 4₂₁ to 4₂₈, 4₃₁ to 4₃₈, and 4₄₁ to 4₄₈ are arranged parallel to each other.

One each of the first conductive lines 4₁₁ to 4₁₈, one each of the first conductive lines 4₂₁ to 4₂₈, one each of the first conductive lines 4₃₁ to 4₃₈, and one each of the first conductive lines 4₄₁ to 4₄₈, which are different from each other, connect to each other via a corresponding one of eight second conductive lines 5₁ to 5₈. More specifically, the first conductive lines 4₁₁, 4₂₁, 4₃₁, and 4₄₁ connect to each other via the second conductive line 5₁; the first conductive lines 4₁₂, 4₂₂, 4₃₂, and 4₄₂, via the second conductive line 5₂; the first conductive lines 4₁₃, 4₂₃, 4₃₃, and 4₄₃, via the second conductive line 5₃; the first conductive lines 4₁₄, 4₂₄, 4₃₄, and 4₄₄, via the second conductive line 5₄; the first conductive lines 4₁₅, 4₂₅, 4₃₅, and 4₄₅, via the second conductive line 5₅; the first conductive lines 4₁₆, 4₂₆, 4₃₆, and 4₄₆, via the second conductive line 5₆; the first conductive lines 4₁₇, 4₂₇, 4₃₇, and 4₄₇, via the second conductive line 5₇; and the first conductive lines 4₁₈, 4₂₈, 4₃₈, and 4₄₈, via the second conductive line 5₈. The second conductive lines 5₁ to 5₈ are arranged parallel to each other in a direction to cross (in FIG. 14, a direction perpendicular to) the first conductive lines 4₁₁ to 4₁₈, 4₂₁ to 4₂₈, 4₃₁ to 4₃₈, and 4₄₁ to 4₄₈.

The input terminals 1₁ to 1₈ respectively connect to the common terminals of the SP8T switches 13₁ to 13₈. End portions of the second conductive lines 5₁ to 5₈ are extracted outside the area where the conductive lines 4₁₁ to 4₁₈, 4₂₁ to 4₂₈, 4₃₁ to 4₃₈, and 4₄₁ to 4₄₈ are arranged and connect to output terminals 2₁ to 2₈. The SP8T switches 13₁ to 13₈ are controlled as a whole such that the eight input terminals 1₁ to 1₈ one-to-one connect to the eight output terminals 2₁ to 2₈.

The first conductive lines 4₁₁ to 4₁₈, 4₂₁ to 4₂₈, 4₁₁ to 4₃₈, and 4₄₁ to 4₄₈ and the second conductive lines 5₁ to 5₈ constitute microstrip lines together with a ground conductor 6 formed on a substrate 9 and a first dielectric layer 8₁ and a second dielectric layer 8₂ sequentially formed on the ground conductor 6. The first conductive lines 4₁₁ to 4₁₈, 4₂₁ to 4₂₈, 4₃₁ to 4₃₈, and 4₄₁ to 4₄₈ are arranged on the first dielectric layer 8₁, and the second conductive lines 5₁ to 5₈ are arranged on the second dielectric layer 8₂. The first conductive lines 4₁₁ to 4₁₈, 4₂₁ to 4₂₈, 4₃₁ to 4₃₈, and 4₄₁ to 4₄₈ and the second conductive lines 5₁ to 5₈ connect to each other via through holes 7₁ formed in the second dielectric layer 8₂ at connecting portions 15 indicated by “▪” in FIG. 14.

This arrangement can decrease the number of conductive lines existing between the opposite switches of each switch pair from 64 in the prior art shown in FIG. 20 with n=8 to eight (the second conductive lines 5₁ to 5₈). Using conductive lines with the same line width and the same line interval, therefore, makes it possible to decrease the interval between the two SP8T switches constituting each of the first to fourth switch pairs to about ⅛ that in the prior art. This can decrease the length of open stubs which exist in sevens for each of the output terminals 2₁ to 2₈ during switching operation to about 1/56 that in the prior art. For this reason, this arrangement allows operation in a bandwidth 50 times or more broader than that in the conventional arrangement with n=8 from which output-side SP8T switches are removed. Furthermore, since the length of the transmission line between input and output terminals in the ON state decreases, insertion loss can be reduced, and the path dependency of insertion loss can be reduced.

In addition, the above arrangement can decrease the number of interconnection intersections from 784 to 180 as compared with the prior art shown in FIG. 20 with n=8. Furthermore, as shown in FIG. 3, the ground conductor 6 and the dielectric layers 8₁ and 8₂ are sequentially formed on the substrate 9, and the thicknesses of the dielectric layers 8₁ and 8₂ are set to several μm to several ten μm. This structure makes it possible to maintain high inter-line isolation even if the line interval is decreased as compared with microstrip lines using a substrate lower surface ground and coplanar waveguides formed on a substrate upper surface. Therefore, a switch with a broader bandwidth can be implemented. Moreover, the above structure can increase a characteristic impedance with a narrow line interval as compared with coplanar waveguides, and hence makes it easy to reduce the capacitance caused by an open stub, thereby improving return loss.

According to the matrix switch shown in FIG. 14, it was confirmed that an 8×8 switch with a bandwidth of about 10 GHz could be implemented by setting the line widths of the first conductive lines 4₁₁ to 4₁₈, 4₂₁ to 4₂₈, 4₃₁ to 4₃₈, and 4₄₁ to 4₄₈ and the second conductive lines 5₁ to 5₈ to about 5 to 10 μm, the thicknesses of the lines to about 1 to 5 μm, and the thicknesses of the first and second dielectric layers 8₁ and 8₂ to about 2 to 5 μm (dielectric constant: about 3).

Note that this embodiment is not limited to the arrangement shown in FIG. 14, and the second conductive lines 5₁ to 5₈ may be formed on the first dielectric layer 8₁, and the first conductive lines 4₁₁ to 4₁₈, 4₂₁ to 4₂₈, 4₃₁ to 4₃₈, and 4₄₁ to 4₄₈ may be formed on the second dielectric layer 8₂ as in the 4×4 switch shown in FIGS. 4 and 5. As shown in FIGS. 8B and 9B, the gaps G may be formed in the ground conductor 6.

### Sixth Embodiment

The matrix switch shown in FIG. 15 is a modification of the matrix switch shown in FIG. 14. According to this matrix switch, output terminals 2₁ to 2₈ are gathered on one side of the matrix switch. The first and second conductive lines 4₁₁ to 4₁₈, 4₂₁ to 4₂₈, 4₃₁ to 4₃₈, 4₄₁ to 4₄₈, and 5₁ to 5₈ are formed on a second dielectric layer 8₂ in orthogonal directions. Note, however, that portions of the first conductive lines 4₁₁ to 4₁₈, 4₂₁ to 4₂₈, 4₃₁ to 4₃₈, and 4₄₁ to 4₄₈ are formed on a first dielectric layer 8₁ at intersections 16 of the first conductive lines 4₁₁ to 4₁₈, 4₂₁ to 4₂₈, 4₃₁ to 4₃₈, and 4₄₁ to 4₄₈ and the second conductive lines 5₁ to 58 except for the connecting portions. These portions connect to the remaining portions of the first conductive lines 4₁₁ to 4₁₈, 4₂₁ to 4₂₈, 4₃₁ to 4₃₈, and 4₄₁ to 4₄₈ on the second dielectric layer 8₂ via through holes 7₁ and 7₂ formed in the second dielectric layer 8₂.

Such an arrangement allows all the transmission lines to have the same arrangement except at the intersections 16. In addition, the conductor thickness of the upper layer can be made thicker than those of the remaining layers, thus making it easy to reduce insertion loss. Note that portions of the second conductive lines 5₁ to 5₈ may be formed on the first dielectric layer 8₁ at the intersections 16 and connect to the remaining portions on the second dielectric layer 8₂ via through holes.

The conductive line width on the first dielectric layer 8₁ is preferably smaller than that on the second dielectric layer 8₂. This makes it possible to reduce the characteristic impedance difference between the conductive lines on the first dielectric layer 8₁ and the conductive lines on the second dielectric layer 8₂ and improve the characteristics of the matrix switch. In addition, gathering the output terminals 2₁ to 2₈ on one side of the matrix switch facilitates extraction of input and output terminals in opposite directions.

Note that this embodiment is not limited to the arrangement shown in FIG. 15. As in the 4×4 switch shown in FIG. 11, the gaps G may be formed in a ground conductor 6 immediately below portions (e.g., a conductive line 4₂₁′) of the conductive lines on the first dielectric layer 8₁. Alternatively, as in the 4×4 switch shown in FIG. 12, conductors 6′ may be formed below the intersections 16 of the first conductive lines 4₁₁ to 4₁₈, 4₂₁ to 4₂₈, 4₃₁ to 4₃₈, and 4₄₁ to 4₄₈ and the second conductive lines 5₁ to 5₈ and connect to the ground conductor 6 on a substrate 9 via through holes 7₃ and 7₄.

As shown in FIG. 14, the output terminals 2₁ to 2₄ and 2₅ to 2₈ may be extracted from different sides. In addition, as shown in FIGS. 8B and 9B, the gaps G may be formed in the ground conductor 6 immediately below the conductive lines on the first dielectric layer 8₁. Furthermore, as shown in FIG. 13, each SP8T switch may comprise eight FETs.

### Other Embodiments

The SP4T switches 3₁ to 3₄ and SP8T switches 13₁ to 13₈ in the above embodiments may comprise micro-mechanical switches (MEMS (Micro-Electro-Mechanical Systems) switches) instead of FETs. Using MEMSs increases the control voltage and prolongs the switching time as compared with a case wherein FETs are used, but can achieve the low insertion loss and high isolation of switches.

In addition, part or all of the above matrix switch is preferably integrated on a semiconductor substrate. That is, a semiconductor substrate is preferably used as a substrate 9.

The above embodiments have exemplified the dielectric layer 8 with the two-layer structure. However, the present invention can use a dielectric layer with a single-layer structure or a dielectric layer with a multi-layer structure comprising three or more layers. When a dielectric layer with a single-layer structure is to be used, first and second conductive lines are arranged on the dielectric layer and the substrate 9 immediately below the dielectric layer. When a dielectric layer comprising three or more layers is to be used, first and second conductive lines may be separately arranged on the three or more layers.

The above embodiments have exemplified the case wherein the first conductive lines 4₁₁ to 4₁₄ and 4₂₁ to 4₂₄ and the second conductive lines 5₁ to 5₄ constitute microstrip lines together with the dielectric layer 8 and the ground conductor 6. However, either the first conductive lines 4₁₁ to 4₁₄ and 4₂₁ to 4₂₄ or the second conductive lines 5₁ to 5₄ may constitute coplanar waveguides together with a ground conductor formed in the same plane.

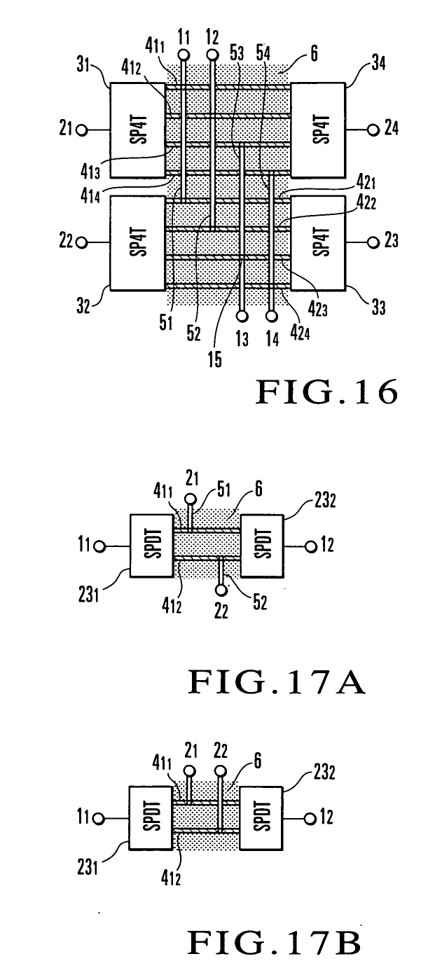

In addition, in the 4×4 switch described above, the input terminals 1₁ to 1₄ and the output terminals 2₁ to 2₄ may be exchanged. That is, the output terminals 2₁ to 2₄ may be used as input terminals, and the input terminals 1₁ to 1₄ may be used as output terminals. For example, FIG. 16 shows the arrangement obtained by exchanging the input terminals 1₁ to 1₄ and the output terminals 2₁ to 2₄ in the matrix switch shown in FIG. 1. In this case, the output terminals 2₁ to 2₄ become the first terminals, and the input terminals 1₁ to 1₄ become the second terminals. Likewise, in the 8×8 switch described above, the input terminals 1₁ to 1₈ and the output terminals 2₁ to 2₈ may be exchanged.

The above description has exemplified the case wherein the present invention is applied to the 4×4 switch and the 8×8 switch. However, the present invention is not limited to this, and may be applied to an n×n switch (n is an even number equal to or more than 2). An n×n switch includes n SPnT switches (1×n switches) grouped in twos to form switch pairs, first conductive lines arranged in ns for each switch pair, and n second conductive lines.

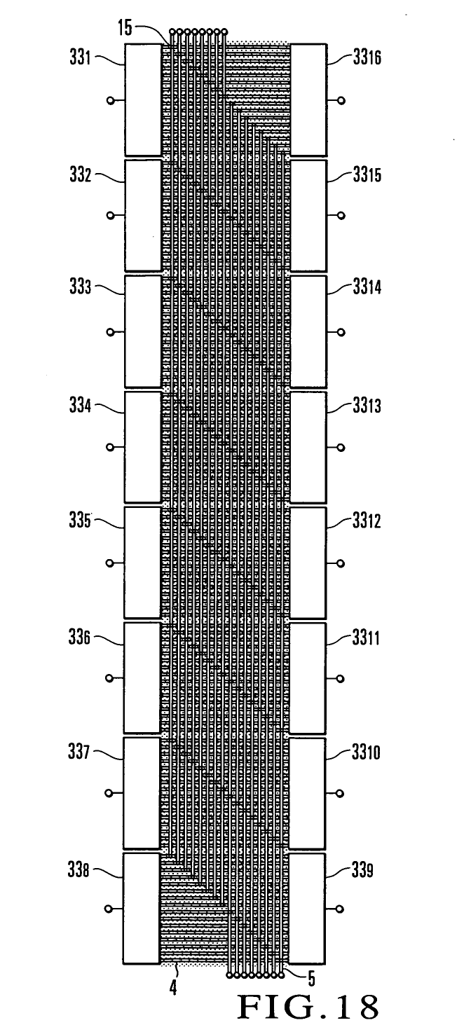

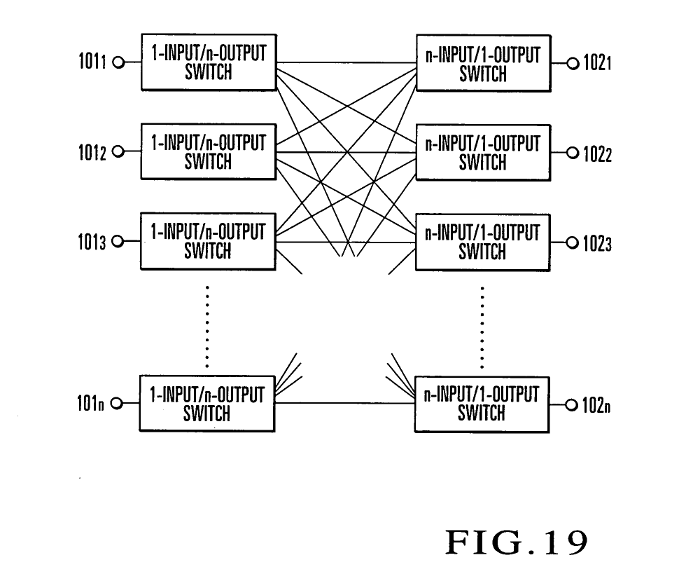

For example, as shown in FIGS. 17A and 17B, a 2×2 switch includes two SPDT switches 23₁ and 23₂, two first conductive lines 4₁₁ and 4₁₂, and two second conductive lines 5₁ and 5₂. In the 2×2 switch shown in FIG. 17A, output terminals 2₁ and 2₂ are arranged on opposite sides of the area where first and second conductive lines 4₁₁, 4₁₂, 5₁, and 5₂ are arranged. In the 2×2 switch shown in FIG. 17B, output terminals 2₁ and 2₂ are arranged on the same side. In addition, as shown in FIG. 18, a 16×16 switch includes 16 SP16T switches 33₁ to 33₁₆ constituting eight switch pairs, first conductive lines 4 arranged in 16 s for each switch pair, and 16 second conductive lines 5.

The above SPnT switch is a switch which functions as both a 1-input/n-output switch and an n-input/1-output switch. The present invention can use a switch having no bidirectionality instead of such an SPnT switch. More specifically, a matrix switch like that shown in FIG. 1 can use 1-input/n-output switches, and a matrix switch like that shown in FIG. 16 can use n-input/1-output switches.

### INDUSTRIAL APPLICABILITY

The matrix switch according to the present invention can be used for a 10 GbE router, network switch, high-speed video signal switcher, optical cross-connect, protection switch, and the like.

1. A matrix switch characterized by comprising:
n (n is an even umber not less than 2) 1×n switches which are grouped in twos to form switch pairs;
first conductive lines arranged in ns for said each switch pair;
n second conductive lines which respectively connect to different lines of said first conductive lines which are respectively arranged on the switch pairs;
a dielectric layer on which said first conductive lines and said second conductive lines are separately arranged on not less than two layers; and
a ground conductor which forms a transmission line together with at least one of said first conductive line and said second conductive line and said dielectric layer,
wherein said 1×n switch comprises one common terminal and n individual terminals arranged on a side different from that of the common terminal,
two 1×n switches forming the switch pair are arranged such that individual terminals of the 1×n switches are spaced apart from each other to face each other, and
said first conductive lines connect the respective individual terminals of said two 1×n switches to each other.

2. A matrix switch according to claim 1, characterized by further comprising
n first terminals which connect to the common terminals of said 1×n switches, and
n second terminals which connect to said second conductive lines.

3. A matrix switch according to claim 2, characterized in that
said first terminal is an input terminal to which a signal is input, and
said second terminal is an output terminal from which a signal is output.

4. A matrix switch according to claim 2, characterized in that
said second terminal is an input terminal to which a signal is input, and
said first terminal is an output terminal from which a signal is output.

5. A matrix switch according to claim 2, characterized by further comprising a control unit which connects to said 1×n switches and controls said 1×n switches to one-to-one connect said n first terminals to said n second terminals.

6. A matrix switch according to claim 1, characterized in that
said dielectric layer comprises a first dielectric layer and a second dielectric layer stacked on the first dielectric layer,
said first conductive lines are arranged on one of the first dielectric layer and the second dielectric layer,
said second conductive lines are arranged on one of the first dielectric layer and the second dielectric layer which is different from the layer on which said first conductive lines are arranged in a direction to cross said first conductive lines, and
the second dielectric layer comprises through holes which connect said first conductive lines to said second conductive lines.

7. A matrix switch according to claim 1, characterized in that
said dielectric layer comprises a first dielectric layer and a second dielectric layer stacked on the first dielectric layer,
said first conductive lines and said second conductive lines are arranged on one of the first dielectric layer and the second dielectric layer in crossing directions,
a portion of one of said first conductive line and said second conductive line is arranged on a layer different from a layer on which a remaining portion is arranged, at an intersection of said first conductive line and said second conductive line except for a connecting portion, and
the second dielectric layer comprises a through hole which connects said portion of one of said first conductive line and said second conductive line to said remaining portion.

8. A matrix switch according to claim 1, characterized in that
said dielectric layer comprises a first dielectric layer and a second dielectric layer stacked on the first dielectric layer,
said first conductive lines and said second conductive lines are arranged on the second dielectric layer in crossing directions,
a portion of one of said first conductive line and said second conductive line is arranged below the first dielectric layer at an intersection of said first conductive line and said second conductive line except for a connecting portion,
the first dielectric layer and the second dielectric layer comprise through holes which connect said portion of one of said first conductive line and said second conductive line to said remaining portion, and
the matrix switch further comprises a conductor which is arranged on the first dielectric layer at the intersection and connects to said ground conductor.

9. A matrix switch according to claim 1, characterized in that
said ground conductor is formed on a substrate, and
said dielectric layer is formed on said ground conductor.

10. A matrix switch according to claim 9, characterized in that said ground conductor comprises a gap immediately below at least one of said first conductive line and said second conductive line.

11. A matrix switch according to claim 1, characterized in that
said dielectric layer comprises a first dielectric layer and a second dielectric layer stacked on the first dielectric layer,
portions of said first conductive line and said second conductive line are arranged on the second dielectric layer,
remaining portions of said first conductive line and said second conductive line are arranged on the first dielectric layer, and
said ground conductor is formed below the first dielectric layer.

12. A matrix switch according to claim 11, characterized in that
a width of a line portion arranged on the first dielectric layer is smaller than a width of a line portion arranged on the second dielectric layer, and
a characteristic impedance of the line portion arranged on the first dielectric layer is the same as a characteristic impedance of the line portion arranged on the second dielectric layer.

13. A matrix switch according to claim 11, characterized in that
said ground conductor comprises a gap immediately below a line portion arranged on at least one of the first dielectric layer and the second dielectric layer, and
a width of the gap is set such that a characteristic impedance of a line portion arranged on the first dielectric layer becomes equal to a characteristic impedance of the line portion arranged on the second dielectric layer.

14. A matrix switch according to claim 2, characterized by further comprising
a third conductive line which connects the common terminal of said 1×n switch to said first terminal, and
a fourth conductive line which connects an end portion of said second conductive line to said second terminal,
wherein said first terminal and said second terminal are arranged on different sides of an area where said first conductive line and said second conductive line are arranged, and
said third conductive line bends from the common terminal to said first terminal.

15. A matrix switch according to claim 14, characterized in that widths of said third conductive line and said fourth conductive line are larger than widths of said first conductive line and said second conductive line.

16. A matrix switch according to claim 1, characterized in that
said 1×n switch comprises one common terminal, n individual terminals, and n field-effect transistors, and
the field-effect transistor has one of a drain electrode and a source electrode connected to the common electrode and the other of the drain electrode and the source electrode connected to the individual terminal.

17. A matrix switch according to claim 1, characterized in that said 1×n switch comprises a mechanical switch.

18. A matrix switch according to claim 1, characterized in that n is 4.

19. A matrix switch according to claim 1, characterized in that n is 8.

20. A matrix switch according to claim 2, characterized by further comprising a control unit which connects to said 1×n switches and controls said 1×n switches to one-to-m (m is an integer not less than 2 and not more than n) connect said n first terminals to said n second terminals.
